(19) United States
(12) Patent Application Publication
(10) Pub. No.: US 2019/0373801 A1
(43) Pub. Date: Dec. 12, 2019

(54) ADJUSTABLE CLOSING SYSTEM

(71) Applicant: CNH Industrial America LLC, New Holland, PA (US)

(72) Inventors: Christopher Schoeny, Yorkville, IL (US); Chad M. Johnson, Arlington Heights, IL (US); Trevor Stanhope, Palos Hills, IL (US); Darian E. Landolt, Evanston, IL (US)

(21) Appl. No.: 16/006,360

(22) Filed: Jun. 12, 2018

(51) Int. Cl. A01C 5/06; A01B 76/00

(52) U.S. Cl. CPC A01C 5/068; A01B 76/00

(57) ABSTRACT

An agricultural implement system that includes a row unit coupled to a tool bar of an agricultural implement. An opener system coupled to the row unit that engages soil to form a trench. A soil condition sensor. A closing system that closes the trench created by the opener system. The closing system includes a first disk that engages the soil and closes the trench. A second disk that engages the soil and closes the trench. A controller that couples to the soil condition sensor and controls a position or orientation of the first disk or the second disk in response to feedback from the soil condition sensor.

### BACKGROUND

The invention relates generally to ground working equipment, such as agricultural equipment, and more specifically, to an implement incorporating a combined down force and depth control system to maintain a substantially uniform seed deposition depth.

Generally, seeding implements are towed behind a tractor or other work vehicle. These seeding implements typically include a ground engaging tool or opener that forms a trench for seed deposition into the soil. In certain configurations, a gauge wheel is positioned a vertical distance above the opener to establish a desired trench depth for seed deposition into the soil. As the implement travels across a field, the opener excavates a trench into the soil, and seeds are deposited into the trench. As will be appreciated, properly closing the trench after depositing seeds facilitates plant growth and crop yields.

### BRIEF DESCRIPTION

In an embodiment, an agricultural implement system that includes a row unit coupled to a tool bar of an agricultural implement. An opener system coupled to the row unit that engages soil to form a trench. A soil condition sensor. A closing system that closes the trench created by the opener system. The closing system includes a first disk that engages the soil and closes the trench. A second disk that engages the soil and closes the trench. A controller that couples to the soil condition sensor and controls a position or orientation of the first disk or the second disk in response to feedback from the soil condition sensor.

In another embodiment, an agricultural implement system that includes a row unit coupled to a tool bar of an agricultural implement. An opener system coupled to the row unit that engages soil to form a trench. A closing system that closes the trench created by the opener system. The closing system includes a first disk that engages the soil and closes the trench and a second disk that engages the soil and closes the trench. A first actuator changes an angle of the first disk relative to the trench. A second actuator changes a distance between the first and second disks along an axis of the trench.

In another embodiment, an agricultural system that includes a soil condition sensor that detects a condition of soil and/or an operational sensor that detects operation of the agricultural system. A controller that couples to the soil condition sensor and/or the operational sensor and in response controls a position of a first disk or a second disk of a closing system to close a trench.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an agricultural implement;

FIG. 2 is a side view of an embodiment of a row unit of the agricultural implement in FIG. 1;

FIG. 3 is a partial side view of an embodiment of an adjustable closing system;

FIG. 4 is a partial rear view of an embodiment of an adjustable closing system;

FIG. 5 is a partial rear view of an embodiment of an adjustable closing system;

FIG. 6 is a partial rear view of an embodiment of an adjustable closing system; and

FIG. 7 is a block diagram of a method for controlling the closing system.

### DETAILED DESCRIPTION

Modern farming uses a variety of agricultural implements to harvest crops, prepare the soil for planting, and for planting. These agricultural implements are commonly referred to as harvesters, tillers, seeders, and planters. Planters enable seed planting by first opening a trench in the soil with an opening system. The planter then deposits seeds into the trench, after which the trench is covered with soil by a closing system. However, certain planting conditions may inhibit seed germination and growth. These planting conditions include inadequate coverage of the seed with soil, excessive coverage of the seed with soil, inadequate seed-to-soil contact, as well as excessive soil compaction around the seed. The planters described below may facilitate germination of the seed and growth of the plant. More specifically, the planter may include an adjustable closing system capable of adjusting the position of one or more discs (e.g., closing discs). For example, the discs may be longitudinally offset with respect to each other, laterally offset from each other, as well as oriented in other ways. By adjusting the position and orientation of the discs, the adjustable closing system is able to respond to different planting conditions to facilitate seed germination and plant growth.

In some embodiments, the position and/or orientation of the discs may be changed in response to feedback from one or more sensors (e.g., soil condition sensors, operational sensors). For example, the planter may include one or more soil condition sensors that detect one or more soil conditions, such as moisture content of the soil, soil flow, soil compaction, soil structure, soil texture, depth of the trench, among others. The planter may also include one or more operational sensors that detect operation of the planter such as operating speed of vehicle (e.g., tractor), vibration, temperature, rotational speed, rotational position, strain, etc. As a controller receives sensor feedback about the soil conditions and/or operational conditions of the agricultural equipment, the controller uses various actuators to change the position and/or orientation of the discs. These adjustments may facilitate covering the seeds with soil and therefore germination and growth.

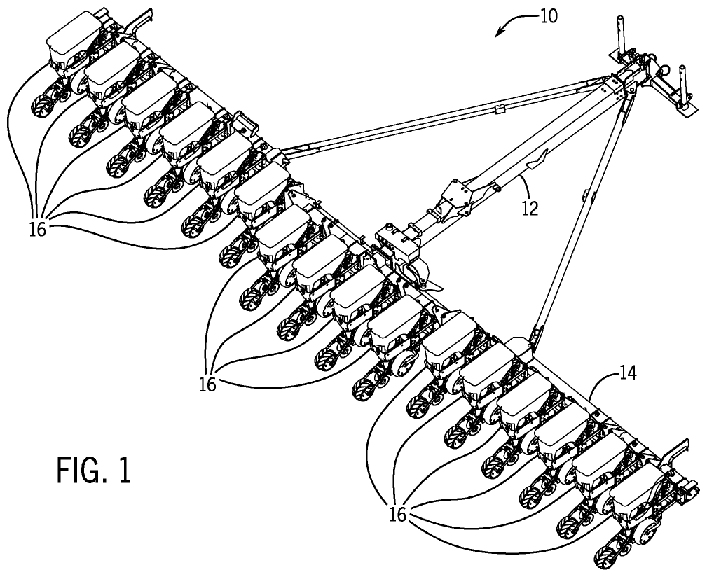

Turning now to the drawings, FIG. 1 is a perspective view of an agricultural implement or system 10 (e.g., planter). The implement 10 is designed to be towed behind a work vehicle such as a tractor. The implement 10 includes a tongue assembly 12 which is shown in the form of an A-frame hitch assembly. The tongue assembly 12 may include a hitch used to attach to an appropriate tractor hitch via a ball, clevis, or other coupling. For example, a tongue of the implement 10 may be connected to a drawbar of the tractor, or a mast of the implement may be connected to a 3-point hitch of the tractor. The tongue assembly 12 is coupled to a tool bar 14 which supports multiple seeding implements or row units 16. In certain embodiments, each row unit 16 includes an opener disc rotatably coupled to a chassis of the row unit 16 and configured to engage soil. The row unit 16 also includes a gauge wheel assembly movably coupled to the chassis. The gauge wheel assembly includes a gauge wheel configured to rotate across a soil surface to limit a penetration depth of the opener disc into the soil. In addition, the row unit 16 includes a depth control actuator extending between the chassis and the gauge wheel assembly. The depth control actuator is configured to adjust the penetration depth of the opener disc by varying the position of the gauge wheel relative to the chassis. A down force actuator extending between the tool bar and the chassis is configured to vary a contact force between the gauge wheel and the soil surface. In some embodiments, the actuator extends between the toolbar and the parallel links and not to the row unit chassis. Each row unit 16 may also include an adjustable closing system that closes the trench formed by the opening system. As will be explained below, the adjustable closing system may include one or more sensors that detect soil conditions and/or operational conditions of agricultural equipment and in response adjusts the position of one or more closing discs, the gauge wheel, etc. to facilitate closing of the trench.

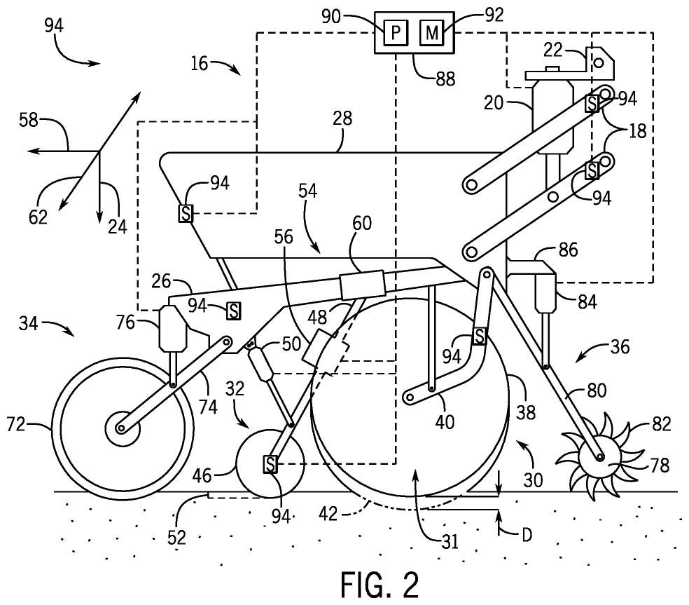

FIG. 2 is a side view of an exemplary row unit 16 that may be employed within the agricultural implement 10 shown in FIG. 1. As illustrated, the row unit 16 includes elements 18 of a parallel linkage assembly, also known as a four-bar linkage, configured to couple the row unit 16 to the tool bar 14, while enabling vertical movement of the row unit 16. In addition, a down force actuator 20 extends between a mounting bracket 22 and a lower portion of the parallel linkage 18 to establish a contact force between the row unit 16 and the soil. The down force actuator 20 is configured to apply a force to the row unit 16 in a downward direction 24, thereby driving a ground engaging tool into the soil. As will be appreciated, a desired level of down force may vary based on soil type, the degree of tillage applied to the soil, soil moisture content, amount of residue cover, and/or tool wear, among other factors. Because such factors may vary from one side of the implement 10 to the other, a different level of down force may be selected for each row unit 16.

Furthermore, a desired level of down force may be dependent on the speed at which the row unit 16 is pulled across the field. For example, as speed increases, the ground engaging tools may have a tendency to rise out of the ground due to the interaction between the soil and the tool. Consequently, a greater down force may be applied during higher speed operation to ensure that the ground engaging tools remain at a desired depth. In addition, the weight of the row unit 16 applies a force to the ground engaging tools in the downward direction 24. However, as seeds and/or other products are transferred from a storage container within the row unit 16 to the soil, the weight of the row unit 16 decreases. Therefore, the down force actuator 20 may apply a greater force to the row unit 16 to compensate. In certain embodiments, the down force actuator 20 may be coupled to a controller 88 configured to automatically regulate the pressure within the down force actuator 20 to maintain a desired contact force between the ground engaging tools and the soil. Because each row unit 16 includes an independent down force actuator 20, the contact force may vary across the implement 10, thereby establishing a substantially uniform seed deposition depth throughout the field. In some embodiments, the down force actuator 20 may retract to apply an upward force. For example, in some environments the planter may work with light soils when the weight of the row unit 16 itself is excessive for the amount of downforce needed.

In the present embodiment, the parallel linkage elements 18 are pivotally coupled to a chassis 26 and a frame 28. In some embodiments, the chassis 26 and the frame 28 may be one-piece or integral (e.g., cast as one-piece). The frame 28 may be configured to support various elements of the row unit 16 such as a metering system and a product storage container, for example. As illustrated, the chassis 26 supports an opener system 30, an adjustable closing system 32, a press wheel assembly 34, and a residue manager assembly 36. In the present configuration, the opener system 30 includes a gauge wheel assembly 31 having a gauge wheel 38 and a rotatable arm 40 which functions to movably couple the gauge wheel 38 to the chassis 26. The gauge wheel 38 may be positioned a vertical distance D above an opener disc 42 to establish a desired trench depth for seed deposition into the soil. As the row unit 16 travels across a field, the opener disc 42 excavates a trench into the soil, and seeds are deposited into the trench. The down force actuator 20 is configured to adjust the penetration depth D of the opener disc 42 by varying a position of the gauge wheel 38 relative to the chassis 26. While the opener system 30 is illustrated with a single disc 42, it should be appreciated that alternative embodiments may include a pair of discs 42 positioned on opposite sides of the chassis 26. In such configurations, the opener discs 42 may be angled toward one another to establish a wider trench within the soil.

As will be appreciated, seeds may be deposited within the excavated trench via a seed tube extending between a metering system within the frame 28 and the soil. The seed tube exit may be positioned aft of the opener system 30 and forward of the closing system 32 such that seeds flow into the trench. Closing discs 46 of the closing system 32 fractures and creates a flow of friable soil from the excavated soil that then closes the trench. As illustrated, the closing system 32 includes a bar 48 extending between the chassis 26 and the closing disc 46. A closing disc actuator 50 is coupled to the bar 48 of the closing system 32, and configured to regulate a contact force between the closing disc 46 and the soil. For example, a large contact force may be applied to effectively push dense soil into the trench, while a relatively small contact force may be applied to close a trench with loose soil. In some embodiments, a large contact force may be applied so that the closing disc 46 penetrates the soil and achieves a proper depth of engagement. While the view illustrates one closing disc 46, it should be appreciated that the closing system 32 may include a pair of discs 46. In addition, certain embodiments may employ closing wheels instead of the illustrated closing discs 46. In some embodiments, the discs 46 may be cutting discs that actually cut into the soil to drive soil into the trench. Accordingly, the actuator 50 may provide the force to drive the disc 46 into the soil a distance 52. In some embodiments, the closing system 32 may include additional actuators 54 that enable the closing system 32 to change the orientation and/or position of one or more discs 46 (e.g., geometry of the closing system 32) in response to detected soil conditions and/or operational conditions of the agricultural implement 10 (e.g., row unit 16).

For example, the closing system 32 may include an actuator 56 that enables the closing system 32 to change the position of the closing disc 46 relative to another disc(s) (e.g., closing disc) along axis/direction 58. In this way, the closing system 32 enables the closing discs 46 to be offset from each other in response to a soil condition and/or an operational condition. The closing system 32 may also include an actuator 60 that changes the position of the closing disc 46 relative to another disc(s) along axis 62. That is, the actuator 60 may increase a width between the closing disc 46 and another disc(s) on an opposite side of the trench. The closing system 32 may also include an actuator(s) 54 (e.g., actuator 60) that changes the yaw, pitch, and/or roll of the closing disc 46. The ability to adjust the geometry of the closing system 32 enables the one or more row units 16 to facilitate a desired seed to soil contact during planting operations by the agricultural implement 10.

In some embodiments, the closing system 32 may include the press wheel assembly 34. As illustrated, the press wheel assembly includes a press wheel 72 positioned aft of the closing disc(s) 46, and serves to pack soil deposited on top of the seeds by the closing disc(s) 46. In the present embodiment, the press wheel assembly 34 includes an arm 74 extending between the chassis 26 and the press wheel 72. A press wheel actuator 76 is coupled to the arm 74 of the press wheel assembly 34, and configured to regulate a contact force between the press wheel 72 and the soil. For example, in dry conditions, it may be desirable to firmly pack soil directly over the seeds to seal in moisture. In damp conditions, it may be desirable to leave the soil over the seeds fairly loose in order to avoid compaction which may result in soil crusting. The process of excavating a trench into the soil, depositing seeds within the trench, closing the trench and packing soil on top of the seeds establishes a row of planted seeds within a field. By employing multiple row units 16 distributed along the tool bar 14, as shown in FIG. 1, multiple rows of seeds may be planted within the field.

Certain embodiments of the row unit 16 may employ a residue manager assembly 36 to prepare the ground before seed deposition. As illustrated, the residue manager assembly 36 includes a wheel 78 coupled to the chassis 26 by an arm 80. The wheel 78 includes points or fingers 82 configured to break up or move aside crop residue on the soil surface. In other words, the residue manager assembly 36, may reduce and/or block deposition of residue in the seed trench which may affect seed germination and emergence. A residue manager actuator 84 extends from a bracket 86 to the arm 80 of the residue manager assembly 36, and is configured to regulate a contact force between the wheel 78 and the soil. While a single residue manager wheel 78 is shown in the present embodiment, it should be appreciated that alternative embodiments may include a pair of wheels 78 angled toward one another.

All of the actuators discussed above (e.g., 20, 50, 54, 56, 60, 76) may be controlled by a controller 88 in order to facilitate opening a trench, closing the trench, and then packing soil deposited over the trench in a way that facilitates seed germination and growth. That is, the controller 88 coordinates operation of the actuators in response to detected soil conditions and/or operating conditions of the agricultural implement 10.

The controller 88 may include a processor 90 and a memory 92 used in processing one or more signals from one or more sensors 94. For example, the processor 90 may be a microprocessor that executes software to control the various actuators on the row unit 16 in response to feedback from the sensors 94. The processor 90 may include multiple microprocessors, one or more “general-purpose” microprocessors, one or more special-purpose microprocessors, and/or one or more application specific integrated circuits (ASICs), field-programmable gate arrays (FPGAs), or some combination thereof. For example, the processor 90 may include one or more reduced instruction set (RISC) processors.

The memory 92 may include a volatile memory, such as random access memory (RAM), and/or a nonvolatile memory, such as read-only memory (ROM). The memory 92 may store a variety of information and may be used for various purposes. For example, the memory 92 may store processor executable instructions, such as firmware or software, for the processor 90 to execute. The memory may include ROM, flash memory, a hard drive, or any other suitable optical, magnetic, or solid-state storage medium, or a combination thereof. The memory may store data, instructions, and any other suitable data.

Soil conditions and/or operating conditions may be detected with one or more sensors 94. For example, some of the sensors 94 may be operational sensors that detect the operation of the agricultural equipment (e.g., discs 46, row unit 16) in response to soil conditions enabling the controller 88 to infer the soil condition or detect actual operation of agricultural equipment. Other sensors 94 may enable direct detection of the soil condition with the controller 88, these sensors may be referred to as soil condition sensors. The sensors 94 may include radar, LIDAR, optical cameras, accelerometers (e.g., to detect vibration), gyroscope (e.g., to detect orientation: roll, pitch, yaw), position sensors (e.g., to detect placement of components relative to row unit frame/chassis), disc rotational velocity sensor (e.g., to detect whether the disc rate of rotation is within expected limits to determine whether the disc is stuck, dragging, sliding, failing, not fully engaged with the ground), disc rotational position sensor (e.g., to detect whether the disc rate of rotation is within expected limits to determine whether the disc is stuck, dragging, sliding, failing, not fully engaged with the ground), torsion sensor (e.g., to detect rolling resistance to determine whether the disc is stuck, dragging, sliding, failing, not fully engaged with the ground), draft sensor (e.g., to detect deflection due to forces on ground engaging components), among others. Other sensors 94 may include radar, LIDAR, and optical cameras that detect how the soil flows as a trench opens with the opening system 30 and/or how the soil flows as the trench is closed. By detecting how the soil responds when moved, the controller 88 may determine the soil structure (e.g., arrangement of soil aggregates), soil texture (e.g., percentage of sand, silt, and clay), and moisture content. In response, the controller 88 executes instructions stored on the memory 92 with the processor 90 that controls one or more of the actuators of the opening system 30, closing system 32, down force actuator 20, etc. to control the movement of soil into the trench and/or soil compaction around the trench. For example, if one or more sensors 94 detect excessively moist soil, the controller 88 may reduce the applied force of the down force actuator 20 to reduce soil compaction (e.g., crusting) by the gauge wheel 38 around the trench. The controller 88 may also adjust the geometry of the closing disc(s) 46 in order to increase breakup of soil as it is deposited into the trench. The control 88 may also control the press wheel actuator 76 to reduce the force of the press wheel 72 on soil covering the trench. In this way the controller 88 may reduce soil compaction around the seed and increase oxygen flow to the seed. In other words reduce smearing and/or crusting around the seeds. As the condition of the soil changes, the sensors 94 detect the changing conditions and in response adjusts the various actuators on the row unit 16.

For example, after passing through an excessively moist area of a field, the agricultural implement 10 may enter an excessively dry section as detected by the sensors 94. In response, the controller 88 executes instructions stored on the memory 92 with the processor 90 that controls one or more of the actuators of the opening system 30, closing system 32, down force actuator 20, etc. to control the movement of soil into the trench and/or soil compaction around the trench. For example, if one or more sensors 94 detect excessively dry soil, the controller 88 may increase the applied force of the down force actuator 20 to improve soil penetration of the opener discs 42 into the soil. The controller 88 may also adjust the geometry of the closing disc(s) 46 in order to reduce breakup of the soil as it is deposited into the trench. The controller 88 may also control the press wheel actuator 76 to increase the force of the press wheel 72 on the soil filling the trench. In this way the controller 88 may increase soil compaction to trap moisture near the seeds.

In some embodiments, the controller 88 may infer soil structure, soil texture, and soil moisture from sensors 94 that detect movement and operation of the row unit 16. For example, the controller 88 may couple to one or more accelerometers, torsion sensors, and position sensors placed at various points on the row unit 16. The feedback from these sensors 94 such as changes in position, force, etc. may enable the controller 88 to infer what the soil condition is and in response adjust one or more actuators on the row unit 16. For example, if a torsion sensor coupled to one or more closing discs 46 indicates that a closing disc(s) 46 is not rotating the controller 88 may infer that the soil is excessively moist and disc 46 is therefore plowing through the field instead of cutting/rolling through the soil. A rapidly changing position as detected by an accelerometer sensor may indicate excessively rough soil. A position sensor may also detect improper position of the discs 46 relative to the frame which may indicate excessive soil compaction, over-applied down force, or under-applied down force. In response the controller 88 may adjust the applied force of the down force actuator 20, actuator 50, adjust the geometry of the closing disc(s) 46 with the actuators 54, and/or control the press wheel actuator 76 to change the force of the press wheel 72 on soil covering the trench. In this way the controller 88 may respond to different soil conditions to facilitate planting and seed germination.

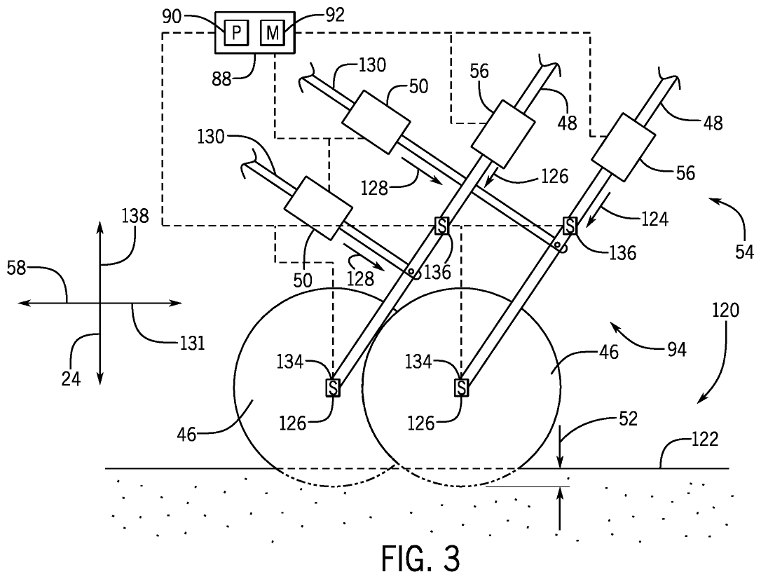

FIG. 3 is a partial side view of the adjustable closing system 32. As explained above, the adjustable closing system 32 includes closing discs 46 that drives excavated soil into the trench, thereby covering the deposited seeds with soil. The adjustable closing system 32 may include one or more closing discs 46. In the illustrated embodiment, the adjustable closing system 32 includes two discs 46. These discs 46 couple to the chassis 26 (not shown) with bars or linkages 48 that extend between the chassis 26 and the closing disc 46. In some embodiments, the discs 46 may be cutting discs that cut into the ground 120 in order to drive soil into the trench formed by the opening system 30. In some embodiments, the closing discs 46 may be press wheels (e.g., V-press wheels) that drive soil into the trench by pressing down on the surface of the soil.

As explained above, the adjustable closing system 32 may change the position of the closing discs 46 in response to soil condition and/or operational conditions in order to facilitate seed germination and plant growth. For example, in an embodiment using cutting discs 46, the adjustable closing system 32 may actuate actuators 50 to increase downward force on the cutting discs 46. The increase in force in direction 128 may enable the cutting discs 46 to penetrate a distance 52 below the surface 122 to drive soil into the trench excavated by the opening system 30. An increase in downward force may also enable soil cutting in more dense soils (e.g., clay, wet soil).

In order to increase the downward force, the actuators 50 and 56 may operate together or independently. For example, in response to a signal from the controller 88, the actuators 56 may provide a force in direction 124. The force in direction 124 is transmitted through the bar 48 to the axle 126 which then drives the discs 46 into the soil. Likewise, the actuators 50 in response to a signal may provide a force in direction 128. The force in direction 128 is transmitted through the bars 130 to the bars 48 and then through the axles 126 to the discs 46. In this way, either actuators 50 and/or 56 may provide a downward force that enables the discs 46 to penetrate into the ground 120. Because each disc 46 is controlled with respective actuators 50 and/or 56, the distance 52 that each disc 46 penetrates the ground 120 may be controlled independently. For example, in response to feedback from one or more sensors 94, the controller 88 may adjust how far each of the discs 46 penetrates into the ground 120. That is, one disc 46 may penetrate the ground a distance greater than the other in order to facilitate covering the trench with soil.

In some embodiments, the actuators 50 and 56 may also change the relative position of the discs 46 in axial directions 58 and 131 to control soil movement into the trench. For example, in response to feedback from one or more sensors 94, the controller 88 may move one or both of the discs 46 in direction 58 and/or move one or both of the discs 46 in direction 131 in order to offset the discs 46. To accomplish this, the controller 88 sends a signal to one or more of the actuators 56 and/or 50 to control contraction or extension of the actuator 50 and/56. As illustrated, contraction and/or extension of the bars 48 and/or 130 enables the discs 46 to move axially in directions 58 and 131. The ability to move the discs 46 in direction 58 and/or 131 enables the discs 46 to be offset from one another in response to sensor feedback to the controller 88.

The actuators 50 and 56 may also enable the discs 46 to be lifted away from the ground 120 as well. For example, the controller 88 through feedback from one or more sensors 94 (e.g., operational sensors or soil condition sensors), may detect that the soil is not flowing as desired into the trench. This may occur due to buildup of mud and/or debris on the discs 46 reducing and/or blocking the discs 46 from rotating. In some situations, debris (e.g., roots, stalks, rocks, leaves) may catch on the discs 46, which is then dragged across the field. For example, a rotation sensor 134 may detect improper rotation of the discs 46. In response, the controller 88 may actuate one or both of the actuators 50 and/or 56 to raise the discs 46 in axial direction 138 away from the ground 120. Raising the discs 46 may enable debris and/or mud to dislodge from the discs 46 enabling them to operate properly once lowered back into position. In some embodiments, the rotation sensors 134 may be supplemented by other types of sensors 94 (e.g., load cell, optical sensors, camera, hall effect sensor, proximity sensor, LIDAR, radar, accelerometer, gyroscope, disc rotation velocity sensor, disc rotational position sensor, torsion sensor, position sensor, draft sensor) that enable the controller 88 to verify the condition before responding. These other sensors 94 may also be used in place of the rotation sensor 134. For example, load cells 136 coupled to the bars 48 and/or 130 may detect that debris and/or mud is blocking rotation and/or otherwise interfering with operation of the closing system 32 as an increasing load is transferred through the bars 48 and/or 130.

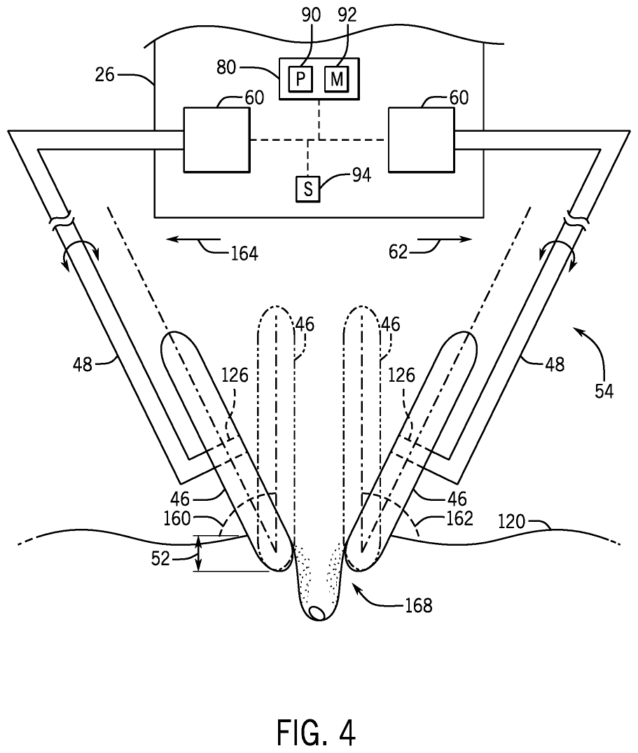

FIG. 4 is a partial rear view of an embodiment of an adjustable closing system 32. For simplicity in describing an aspect of the closing system 32, not all of the actuators 54 seen in FIG. 2 are included in FIG. 4. As explained above, the closing system 32 may enable independent movement of the discs 46 in response to the detection of soil conditions and/or operational conditions by sensors 94. In FIG. 3, the closing system 32 illustrated actuators 54 that enable the discs 46 to be offset from one another with respect to an axis of the trench as well as in a direction orthogonal or substantially orthogonal to the axis of the trench. FIG. 4 illustrates an embodiment of the closing system 32 that enables angular displacement of the discs 46 with respect to the ground 120.

As explained above, the controller 88 receives feedback from one or more sensors 94 that detect soil conditions and/or operational conditions. In response to this feedback the controller 88 controls operation of the one or more actuators 54 to change the position of one or more discs 46. In order to change an angle 160 and 162 of the discs 46 with respect to the ground 120, the controller 88 actuates actuators 60 coupled to the bars 48. As the actuators 60 move the bars 48 along axis/directions 62 and 164, the respective angles 160 and 162 change with respect to the ground 120. For example, the angles 160 and 162 may be adjusted between 10-120 degrees, 30-90 degrees, 50-70 degrees, etc. with respect to the ground 120. It should be understood that the discs 46 may be actuated independent of each other to enable the closing system 32 to place the discs 46 at the same angle or different angles with respect to each other. By changing the angle of the discs 46 with respect to the ground 120, may facilitate closure of the trench 168 with soil in different planting conditions.

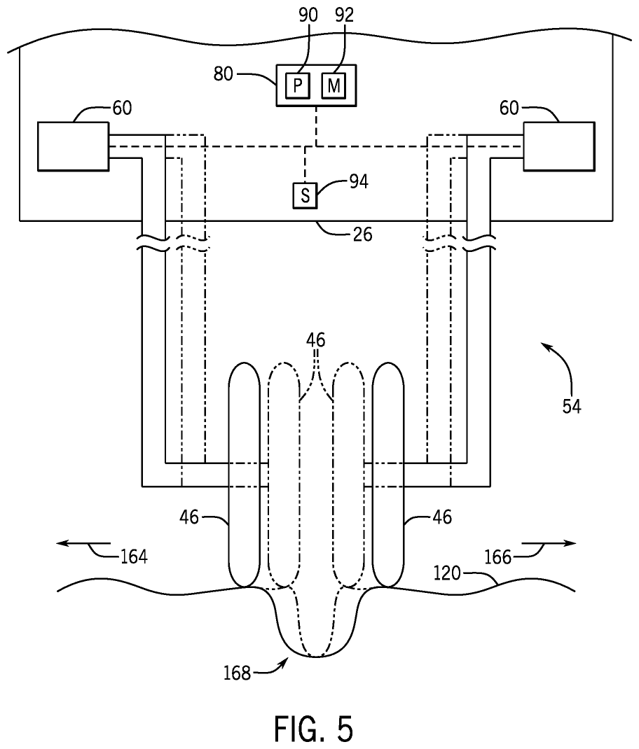

FIG. 5 is a partial rear view of an embodiment of an adjustable closing system 32. For simplicity in describing an aspect of the closing system 32, not all of the actuators 54 seen in FIG. 2 are included in FIG. 5. As explained above, the closing system 32 may enable the independent movement of the discs 46 in response to the detection of a soil condition and/or an operational condition by sensors 94. In FIGS. 3 and 4, the actuators of the closing system 32 enable the discs 46 to be offset from one another with respect to an axis of the trench in the direction of travel, offset from one another in a direction orthogonal or substantially orthogonal to the axis of the trench, as well as angular displacement of the discs 46 relative to the ground 120. FIG. 5 illustrates an embodiment of the closing system 32 that enables displacement of the discs 46 relative to the trench 168 and to each other.

In operation, the controller 88 receives feedback from one or more sensors 94 that detect soil condition and/or operational conditions. In response to this feedback the controller 88 controls operation of the one or more actuators 54 to change the position of one or more discs 46. In order to change the position of the discs 46 in directions 164 and 166, the controller 88 actuates actuators 60 coupled to the bars 48. As the actuators 60 move the bars 48 in directions 164 and 166, the relative position of the discs 46 to each other and to the trench 168 change. It should be understood that the discs 46 may be actuated independently enabling the closing system 32 to place the discs 46 at different positions relative to sides of the trench 168. For example, one of the discs 46 may be closer to the trench 168 than the other disc 46. By changing the position of the discs 46 relative to the trench 168, the controller 88 is able to facilitate closure of the trench 168 in different soil conditions.

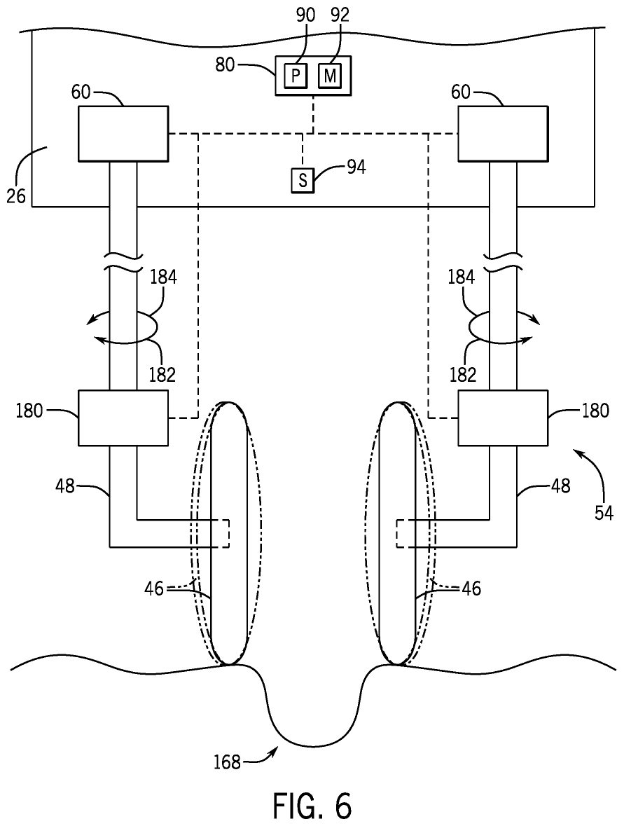

FIG. 6 is a partial rear view of an embodiment of an adjustable closing system 32. For simplicity in describing an aspect of the closing system 32, not all of the actuators 54 seen in FIG. 2 are included in FIG. 6. As explained above, the closing system 32 may enable independent movement of the discs 46 in response to the detection of soil conditions and/or operation of the agricultural implement 10 (e.g., discs 46, row unit 16). In FIGS. 3-5, the closing system 32 illustrates actuators that enable the discs 46 to be offset from one another with respect to an axis of the trench, offset from one another in a direction orthogonal or substantially orthogonal to the axis of the trench, as well as angular displacement of the discs 46 relative to the ground 120. FIG. 6 illustrates an embodiment of the closing system 32 that enables rotation of the discs 46.

As explained above, the controller 88 receives feedback from one or more sensors 94 that detect soil conditions and/or operational conditions. In response to this feedback the controller 88 controls operation of the one or more actuators 54 to change the position one or more discs 46. In order to rotate the discs 46, the controller 88 actuates actuators 180 coupled to the bars 48. As the actuators 180 rotate the bars 48 in directions 182 or 184, the discs 46 likewise rotate. For example, the actuators 180 may rotate the discs 46 between 0-360 degrees. It should be understood that the discs 46 may be actuated independent of each other to enable the closing system 32 to place the discs 46 at symmetric or asymmetric angles with respect to the seed trench. The ability to rotate the discs 46 may facilitate movement of soil in different planting conditions and thus closure of the trench 168.

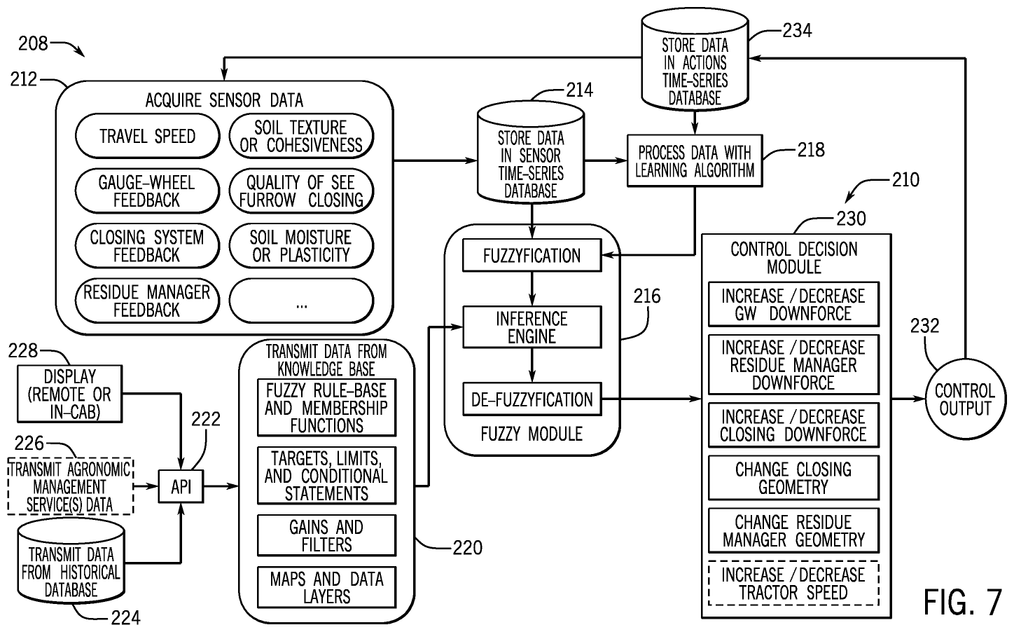

FIG. 7 is a block diagram of an embodiment of a process 208 used by a control system 210 (e.g., controller 88) for controlling the closing system 32 and other systems/assemblies on the implement 10 (e.g., residue manager assembly 36, press wheel assembly 34, gauge wheel 38, etc.). The process 208 begins as the control system 210 receives feedback from a variety of sensors 94, block 212. The sensors 94 enable the control system 210 to understand current operating conditions as well as soil conditions and then respond to changes of those conditions. As illustrated, sensor feedback may include travel speed of the implement and/or vehicle, soil textures, soil cohesiveness, gauge-wheel feedback, closing system feedback, residue manager feedback, soil moisture, soil plasticity, among others.

The data collected by these sensors 94 may then be stored in a sensor time-series-database that enables the control system 210 to collect sensor feedback as it changes over time, block 214. And as will be explained below, collection of data by the sensors over time enables to control system 210 to determine whether adjustments made by the control system 210 to the closing system 32 and other systems on the implement 10 are facilitating planting of the seeds (e.g., appropriately covering the seeds in the trench). The sensor data collected in the sensor time-series-database, may be then be transmitted to a fuzzy module, block 216, as well as to a learning algorithm that processes the data with a processor, block 218.

The fuzzy module executed by the processor receives the sensor data and converts the data into fuzzy values (e.g., values that exist between completely true and completely false statements). For example, sensor feedback may indicate that the trench is partially closed instead of completely closed. The fuzzy module, executed by the processor, assigns a value indicative of how closed the trench is between scalar values that indicate the trench is completely open or completely closed. The fuzzy values may then be transmitted to an inference engine of the fuzzy module. The inference engine receives the fuzzy values as well as information stored in a knowledge base, block 220, that contains a variety of information including fuzzy rule-base and membership functions; targets, limits, and conditional statements; gains and filters; maps and data layers; among other information. In operation, the inference engine receives the fuzzy values and information from the knowledge base and applies logic rules to the fuzzy values and to the information in the knowledge base to determine an appropriate response. As illustrated, the knowledge base may couple to an application programming interface, block 222. The application programming interface enables data from a variety of sources to be fed into the knowledge base, block 220. For example, the application programming interface, block 222, may enable data transfer from historical databases 224, agronomic management services 226, displays 228 (e.g., remote displays, displays in a cab of the agricultural working vehicle towing the implement).

For example, the inference engine may receive a sensor value for a soil moisture measurement for the downforce control system. The inference engine might have several separate membership functions defining particular moisture ranges needed to control the gauge wheel downforce, defining particular moisture ranges needed to control the gauge wheel downforce, and as well as moisture ranges needed to control the closing system downforce. Each function maps the same soil moisture value to a truth value in the range of 0 to 1. These truth values can then be used to determine how the downforce systems should be controlled.

In another example, the inference engine may receive sensor values (e.g., planting or operational conditions both current and past) which after fuzzification are mapped to membership functions for whether the trench is fully open, partially open, or fully closed. The inference engine may also receive data from maps stored in the knowledge base indicating a specific type of soil in vicinity of the trench. The inference engine may then apply further fuzzification of the soil type into separate membership functions defining texture ranges needed to control the closing system 32 (e.g., adjust the geometry of the closing discs). While two examples have been discussed, it should be understood that the inference engine of the fuzzy module may use all or any combination of data in the knowledge base in combination with the fuzzy values to determine a particular adjustment(s) to be made to the closing system 32 and/or other systems on the implement 10 to facilitate planting operations.

After the inference engine aggregates the numerous input values (both current and past), rule bases, logical operations, and other states of the implement 10 (e.g., current sensor values, previous control actions) via fuzzy membership functions, the fuzzy module may then perform a defuzzification operation to produce crisp value(s) to be used by the control system 210 in controlling the systems on the implement 10. The value(s) may then be received by a control decision module 230, executed by the processor, that determines whether to increase/decrease gauge wheel downforce, increase/decrease residue manager downforce, increase/decrease downforce of the closing system 32, change the geometry of the closing system 32, change geometry of the residue manager, increase/decrease downforce of the press wheel, increase/decrease the speed of the tractor, etc. The processor, using the control decision module, then produces a control output for controlling the systems above (e.g., gauge wheel downforce, geometry of the closing system 32, residue manager downforce, downforce of the closing system 32, etc.), block 232.

As the closing system 32, and various other systems on the implement respond their actions are collected and stored in an action time-series database, block 234. This database enables the control system 210 to collect and correlate actions performed and their result as detected by the sensors 94. For example, the learning algorithm may receive data from the actions time-series database and from the sensor time-series database. In operation, the learning algorithm correlates the actions taken with the corresponding results using the sensor feedback. Over time, the learning algorithm learns what the expected results are from specific actions. This information may then be sent to the fuzzy module to facilitate control of the closing system 32 as well as other systems on the implement 10.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An agricultural implement system, comprising:
a row unit coupled to a tool bar of an agricultural implement;
an opener system coupled to the row unit and configured to engage soil to form a trench;
a soil condition sensor;
a closing system, configured to close the trench created by the opener system, the closing system comprises:
a first disk configured to engage the soil and close the trench;
a second disk configured to engage the soil and close the trench; and
a controller configured to couple to the soil condition sensor and control a position or orientation of the first disk or the second disk in response to feedback from the soil condition sensor.

2. The system of claim 1, comprising a first actuator configured to change an angle of the first disk relative to the trench.

3. The system of claim 1, comprising a second actuator wherein the second actuator is configured to change a distance between the first and second disks along an axis of the trench in a direction of travel of the agricultural implement.

4. The system of claim 1, wherein the first and second disks are V-press wheels configured to close the trench and compact the soil around a seed.

5. The system of claim 1, wherein the first disk comprises a first cutting surface and the second disk comprises a second cutting surface, and wherein the first and second cutting surfaces are configured to cut into the soil to close the trench.

6. The system of claim 5, comprising a third actuator, wherein the third actuator is configured to change a distance between a first central axis of the first disk or a second central axis of the second disk and a surface of the soil.

7. The system of claim 1, wherein the soil condition sensor comprises at least one of an optical sensor, RADAR, a camera, a temperature sensor, and LIDAR.

8. The system of claim 1, comprising, a press wheel assembly movably coupled to a chassis of the row unit and comprising a press wheel configured to rotate over the soil and to pack soil over deposited seeds.

9. The system of claim 8, a press wheel actuator extending between the chassis and the press wheel assembly, wherein the press wheel actuator is configured to vary a contact force between the press wheel and a surface of the soil.

10. The system of claim 1, comprising an operational sensor, the operational sensor comprises at least one of an accelerometer, a gyroscope, a position sensor, a disc rotational velocity sensor, a disc rotational position sensor, a torsion sensor, and a draft sensor, and wherein the controller is configured to couple to the operational sensor and control a position or orientation of the first disk or the second disk in response to feedback from the operational sensor.

11. An agricultural implement system, comprising:
a row unit coupled to a tool bar of an agricultural implement;
an opener system coupled to the row unit and configured to engage soil to form a trench;
a closing system, configured to close the trench created by the opener system, the closing system comprises:
a first disk configured to engage the soil and close the trench;
a second disk configured to engage the soil and close the trench;
a first actuator configured to change an angle of the first disk relative to the trench; and
a second actuator configured to change a distance between the first and second disks along an axis of the trench.

12. The system of claim 11, wherein the first and second disks are V-press wheels configured to close the trench and compact the soil around a seed.

13. The system of claim 11, wherein the first disk comprises a first cutting surface and the second disk comprises a second cutting surface, and wherein the first and second cutting surfaces are configured to cut into the soil to close the trench.

14. The system of claim 13, comprising a third actuator, wherein the third actuator is configured to change a distance between a first central axis of the first disk or a second central axis of the second disk and a surface of the soil.

15. The system of claim 11, comprising a soil condition sensor and/or an operational sensor configured to detect a condition of the soil or operation of the agricultural implement system.

16. The system of claim 15, wherein the soil condition sensor and the operational sensor comprise at least one of an optical sensor, RADAR, a camera, a temperature sensor, LIDAR, an accelerometer, a gyroscope, a position sensor, a disc rotational velocity sensor, a disc rotational position sensor, a torsion sensor, and a draft sensor.

17. The system of claim 15, comprising a controller configured to couple to the soil condition sensor and/or the operational sensor to control a position or a force of engagement with the soil of the first disk or the second disk in response to feedback from the soil condition sensor and/or the operational sensor.

18. An agricultural system, comprising:
a soil condition sensor configured to detect a condition of soil and/or an operational sensor configured to detect operation of the agricultural system; and
a controller configured to couple to the soil condition sensor and/or the operational sensor and in response control a position of a first disk or a second disk of a closing system to close a trench.

19. The system of claim 18, wherein the soil condition sensor and the operational sensor comprise at least one of an optical sensor, RADAR, a camera, a temperature sensor, LIDAR, an accelerometer, a gyroscope, a position sensor, a disc rotational velocity sensor, a disc rotational position sensor, a torsion sensor, and a draft sensor.

20. The system of claim 18, comprising an actuator, wherein the controller is configured to control the actuator to change a position of the first disk relative to the second disk.
